(19) United States
(12) Patent Application Publication
(10) Pub. No.: US 2026/0154221 A1
(43) Pub. Date: Jun. 4, 2026

(54) SYSTEM AND APPARATUS FOR MANAGING ONE OR MORE TARGET DEVICES VIA INTEGRATED VIDEO AND PERIPHERAL CONTROLS

(71) Applicant: Cytrence Technologies, Inc., Burlington, MA (US)

(72) Inventors: Hui Li, Lexington, MA (US); Quansheng Liang, Lexington, MA (US)

(21) Appl. No.: 19/177,425

(22) Filed: Apr. 11, 2025

Related U.S. Application Data
(60) Provisional application No. 63/634,240, filed on Apr. 15, 2024.

(51) Int. Cl. G06F 13/38; G06F 13/42

(52) U.S. Cl. CPC G06F 13/382; G06F 13/4282; G06F 2213/0042

(57) ABSTRACT

Systems, devices, and methods are described for interacting with a target computing device through peripheral control devices of a host computing device. In at least one embodiment, a device, such as an integrated video and peripheral control device, may receive video and/or audio inputs from a target device, modify, and send the modified video and/or audio signals to (e.g., an application of) a host computing device. The application may then render the video and/or audio signals. The integrated video and peripheral control device may receive one or more control message(s) from one or more peripheral controls devices of the host computing device (e.g., through the application), and provide emulation of the peripheral control device(s) to interact with the target computing device.

### CROSS-REFERENCE TO RELATED APPLICATIONS

This application claims the benefit of U.S. Provisional Application No. 63/634,240, filed Apr. 15, 2024, entitled “UNIFIED DEVICE PERIPHERAL INTERFACE CONTROL SYSTEM AND METHOD,” the contents of which are incorporated by reference herein in their entirety.

### BACKGROUND

In recent years, the computing landscape has undergone significant transformation with the emergence of single-board computers (SBCs) like the Raspberry Pi, mini-PCs such as Intel NUC, and advanced edge computing devices like Nvidia Jetson modules. These compact compute devices offer substantial computational power, small size, and PC-like functionality, complete with video/audio outputs and the capability to interface with keyboards and mice. Their appeal cuts across a wide user base, including hobbyists, computer science students, and professionals in computer engineering and robotics, owing to their versatility and efficiency. Despite their advantages, incorporating these devices into daily applications presents certain challenges. To fully utilize these compute devices, users traditionally need a complete setup of peripheral devices, including a monitor, keyboard, and mouse. This requirement can demand considerable space and introduce complications in their operational use, highlighting the need for more streamlined solutions in leveraging the potential of these powerful, compact computing platforms.

Addressing the practical challenges of utilizing these compact computing devices, several deficiencies in current solutions have become apparent, significantly impacting user experience and adoption. Firstly, many users face constraints related to space and budget, preventing them from dedicating separate peripherals like monitors, keyboards, and mice for these compact computing devices. The necessity to repeatedly disconnect these peripherals from their primary computers for temporary use deterring their frequent and easy utilization.

Furthermore, while KVM switches can offer a partial remedy in some examples by enabling control over multiple devices via a single set of peripherals, they fall short by not supporting simultaneous access to these systems. This limitation can restrict users'ability to efficiently manage and interact with multiple devices concurrently, constraining the usability and flexibility of their computing setups.

Remote access solutions have been used as an alternative to bypass the need for direct physical connections to peripherals. However, this approach introduces its own set of challenges, including the dependency on stable network connections, the experience of latency issues which can hinder real-time interaction, and a notable degradation in video quality in some examples. These drawbacks collectively compromise the effectiveness of remote access as a reliable solution for controlling and interacting with single-board and edge computers.

These prevalent limitations underscore the need for innovative solutions that enable seamless control across a variety of computing devices, including compact computing devices, with a single set of peripheral devices. In view of the foregoing, a need exists for an improved system and apparatus for managing one or more target devices via integrated video and USB peripheral controls to address one or more of the aforementioned obstacles and deficiencies of conventional peripheral management systems.

### BRIEF DESCRIPTION OF THE DRAWINGS

Various techniques will be described with reference to the drawings, in which:

FIG. 1 illustrates an example integrated video and peripheral control device connected to a single target computing device, in accordance with at least one embodiment;

FIG. 2 illustrates another example integrated video and peripheral control device connected to multiple target computing devices, in accordance with at least one embodiment;

FIGS. 3-10 illustrate different example architectures of an integrated video and peripheral control device, such as the integrated video and peripheral control device of FIG. 1, in accordance with at least one embodiment;

FIGS. 11 and 12 illustrate different example implementations of a multi-device integrated video and peripheral control device, such as the integrated video and peripheral control device of FIG. 2, in accordance with at least one embodiment;

FIG. 13 illustrates an example process of converting video/audio data that may be performed by various components of the integrated video and peripheral control device of any of FIGS. 1-12, in accordance with at least one embodiment;

FIG. 14 illustrates an example process of converting control messages of peripheral devices that may be performed by various components of the integrated video and peripheral control device of any of FIGS. 1-12, in accordance with at least one embodiment;

FIG. 15 illustrates an example diagram of a target device control application, such as may be performed by a host computing device such as may be connected to any of the integrated video and peripheral control devices of FIGS. 1-12, in accordance with at least one embodiment;

FIG. 16 illustrates a more detailed example of the video and audio modules of the target device control application of FIG. 15, in accordance with at least one embodiment;

FIG. 17 illustrates a more detailed example of the peripheral control module(s) of the target device control application of FIG. 15, in accordance with at least one embodiment;

FIGS. 18-20 illustrate example views of a graphical user interface that may be provided by a target device control application of FIG. 13, in accordance with at least one embodiment; and

FIG. 21 illustrates an example process that may be performed by the target device control application of FIG. 13, in accordance with at least one embodiment.

### DETAILED DESCRIPTION

The field of compact computing has given rise to an assortment of devices that demand intuitive and streamlined control mechanisms. Addressing this need, various embodiments discussed herein relate to innovative systems and methods configured to facilitate the control and operation of such compact computing devices.

Systems, devices, and methods are described for interacting with a target computing device through peripheral control devices of a host computing device. In at least one embodiment, a device, such as an integrated video and peripheral control device, may receive video and/or audio inputs from a target device, modify, and send the modified video and/or audio signals to (e.g., an application of) a host computing device. The application may then render the video and/or audio signals. The integrated video and peripheral control device may receive one or more control message(s) from one or mor peripheral controls devices of the host computing device (e.g., through the application), and provide emulation of the peripheral control device(s) to interact with the target computing device.

In at least some embodiments, an integrated video and peripheral control device, may include one or more of the following components: one or more processors; an upstream connector that supports a universal serial bus (USB) 3.0 or higher standard in communication with the one or more processors; a first downstream connector that supports one or more of a high-definition multimedia interface (HDMI) standard or a display port standard for communication of video signals in communication with the one or more processors; a second downstream connector that supports a USB 1.1 or higher standard in communication with the one or more processors; and memory that stores computer-executable instructions that, if executed, cause the one or more processors perform one or more operations for providing an interface between a target computing device (e.g., a limited functionality computing device) and a host computing device (e.g., a desktop, laptop, server, or other computing device having or being connected to one or more peripheral controls devices. In some embodiments, the one or more processors of the integrated video and peripheral control device may receive video input from a target computing device via the first downstream connector; convert the received video input into USB 3.0 or higher video signal; and present the USB 3.0 or higher video signal via a USB Video Class (UVC) interface through the upstream connector to a host computing device. In yet some embodiments, the one or more processors of the integrated video and peripheral control device may receive one or more control messages from the host computing device via the upstream connector, the one or more control messages comprises instructions received from one or more peripheral control devices in communication with the host computing device; convert the one or more control messages into one or more human interface device (HID) reports or messages(or other form usable by the target computing device); and using the one or more HID reports, provide emulation of the one or more peripheral control devices to the target computer via the second downstream connector.

In some cases, the integrated video and peripheral control device includes a USB interface that provides one or more of a USB video output or a USB port for communication with the host computing device. In some cases, the integrated video and peripheral control device of claim 1, may include a first processor and a second processor, where the instructions that, if executed, cause the first processor to: receive the video input from the target computing device via the first downstream connector; convert the received video signals into USB 3.0 or higher video signals; and present the USB 3.0 or higher video signals via the UVC interface through the upstream connector to the host computing device. In this example, the instructions, if executed, cause the second processor to: receive the one or more control messages from the host computing device via the upstream connector; convert the one or more control messages into the one or more HID reports; and using the one or more HID reports, provide the USB keyboard and USB mouse emulation to the target computer via the second downstream connector. In some examples, the first processor includes one of a video processing chip or a graphics card. In some examples, one or more of the first processor or the second processor includes or is implemented on or in a microcontroller unit. In yet some examples, the second processor includes a USB communication component or a USB serial chip.

In various cases, the peripheral controls devices may include a mouse and a keyboard. In some cases, the integrated video and peripheral control device includes second memory in communication with the upstream connector and the second downstream connector that provides data storage of user data communicated through the upstream connector. In yet some cases, the integrated video and peripheral control device includes second memory in communication with the upstream connector and the second downstream connector that provides shared storage of user data between host computing device through the upstream connector and the target computing device through the downstream connector.

In some cases, the integrated video and peripheral control device may include multiple units of device control modules for interacting with different and multiple targeting computing devices, such that one upstream connector may be shared between multiple sets of downstream connectors. For example, a second device control module may include a third downstream connector that supports one or more of the HDMI standard or the display port standard for communication of video signals in communication with the one or more processors; and a fourth downstream connector that supports a USB 1.1 or higher standard in communication with the one or more processors. This second device control module may perform similar operations as a first device control module, including: receiving video input from a second target computing device via the third downstream connector; converting the received video signals into USB 3.0 or higher video signals; presenting the USB 3.0 or higher video signals via the or another UVC interface through the upstream connector to the host computing device; and/or receiving one or more control messages from the host computing device via the upstream connector, the one or more control messages comprises instructions received from the one or more peripheral control devices in communication with the host computing device; converting the one or more control messages into one or more HID reports; and using the one or more HID reports, providing emulation of the one or more peripheral control devices to the target computer via the fourth downstream connector. In some cases, the second device control module may be its own distinct device with at least a separate processor, and in some cases, separate memory (in some cases, the memory may be shared, such as when a processor includes parallel computing capabilities, or in the case when two processors are run in parallel). In other cases, functionality between two or more device control modules may be implemented on the same hardware (e.g., using separate threads or via any of a number of known virtualization techniques).

In some embodiments, such as in the multi-target device integrated video and peripheral control device described above, the integrated video and peripheral control device may include a hub device in communication with the one or more processors, the one or more second processors, and the memory, where the memory stores additional computer-executable instructions that, if executed, further cause the one or more second processors to route the video input and the second video input from the target computing device and the second target computing device to the host computing device; and route control messages from the host computing device to the corresponding target computing device or the second target computing device. In some cases, this may be achieved by assigning different identifiers (e.g., alpha numeric, or any of a variety of other forms) to messages relating to each of the connected target devices. In some cases, the identifiers may be unique. In other cases, the identifiers may be based on communication ports or interfaces of the integrated video and peripheral control device such that the identifier may be reused and may only be unique relative to the other interfaces of the integrated video and peripheral control device. In this example, the one or more processors may be part of a first control device and the one or more second processors may be part of a second control device. In some examples, the control device and the second control device may be in communication with the hub device via one or more separate USB connections.

In some embodiments, the integrated video and peripheral control device, may include one or more processors; an upstream connector connected to the one or more processors; a first downstream connector that supports communication of one or more of video or audio signals, wherein the first downstream connector is in communication with the one or more processors; a second downstream connector in communication with the one or more processors; and memory that stores computer-executable instructions that, if executed, cause the one or more processors to perform a number of operations. In some cases, those operations may include receiving video input from a target computing device via the first downstream connector; converting the received video signals into processed video signals; and presenting the processed video signals via a video interface through the upstream connector to a host computing device. In some cases, those operations may additionally or alternatively include receiving one or more control messages from the host computing device via the upstream connector, the one or more control messages comprises instructions received from one or more peripheral control devices in communication with the host computing device; converting the one or more control messages into one or more human interface device (HID) reports; and using the one or more HID reports, provide emulation of the one or more peripheral control devices to the target computer via the second downstream connector. In some cases, the integrated video and peripheral control device may be part of an integrated video and peripheral control system, where the system also includes a target device control application executable by the host computing system. In some cases, the target device control application may obtain one or more peripheral control device inputs; and may convert the one or more peripheral control device inputs into one or more control messages prior to sending the one or more control messages to the target computing device through the integrated video and peripheral control device. In yet some cases, the target device control application may also upon obtaining the processed video signals, render the processed video signals in a graphical user interface provided by the target device control application.

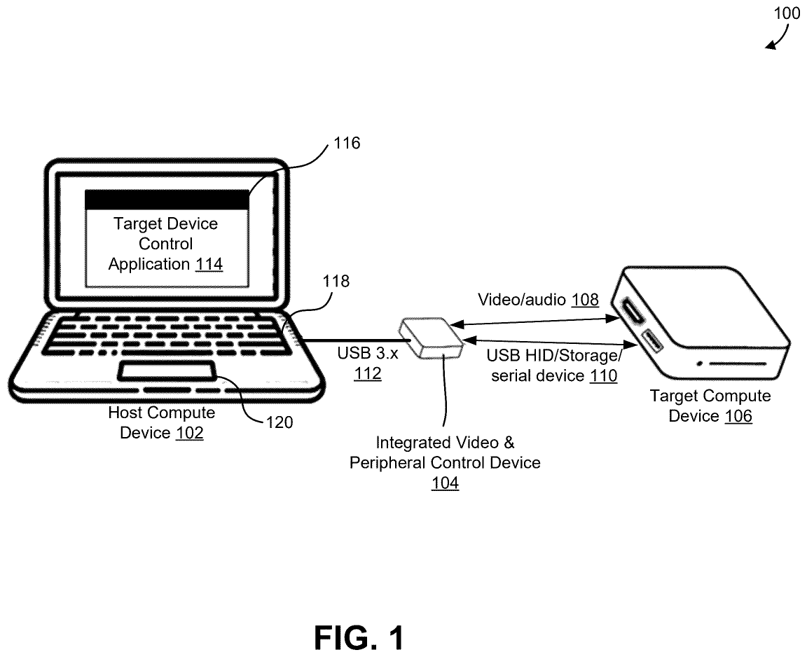

As illustrated in FIG. 1, various embodiments include one or more of the following components: a host computer or compute device 102, a target compute device 106, an integrated video and peripheral control apparatus or device 104, and an associated target device control application 114. In various embodiments, the integrated video and peripheral control apparatus 104 utilizes a USB 3.x or faster (e.g., USB 4.0) connection 112 to communicate with the host computer 102. In various examples, such a physical USB cable connection typically includes both USB 3.x data lines dedicated to high-speed video transport and USB 2.0 data lines that can be utilized separately for control messages.

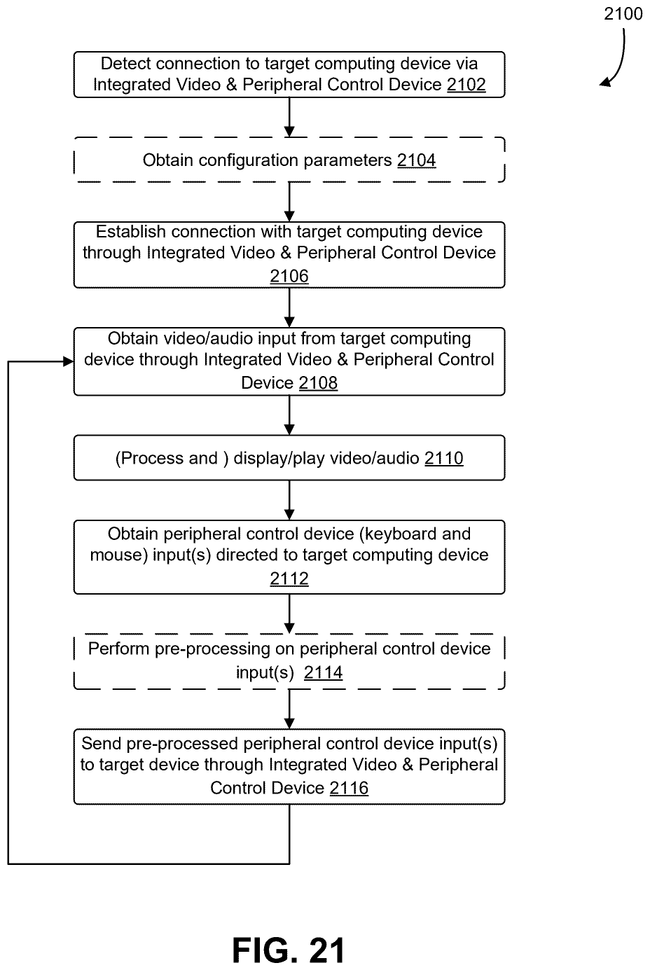

The host computer 102, in some embodiments, can comprise a conventional PC (e.g., desktop or laptop or the like), which can serve as the operational equipment for a software application 114 configured to perform at least a portion of the methods and processes discussed herein, such as process 2100 described below in reference to FIG. 21. In various embodiments, the host computer 102 can be any suitable computing device and can include a processor and memory (e.g., a non-transitory computer readable medium) that stores instructions, that when executed by the processor, causes performance one at least a portion of a method such as discussed herein. Host computing device 102 may also include any of a number of different peripheral controls/devices, such as a keyboard 118 and mouse or mouse pad 120. It should be appreciated that host computing device 102 may be interface with a variety of different peripheral control devices, such as optical devices, virtual devices, other physical devices such as game controllers, joysticks, etc. In these different examples, the integrated video and peripheral control device 104 may interface with these devices through the target device control application 114 to enable control of the target computing device 106, as will be described in greater detail below.

The target computing device or target device 106, in some embodiments, can represent a broad category of computing systems, including compact computing machinery such as single-board computers like the Raspberry Pi, mini PCs, and sophisticated edge computing devices like the Nvidia Jetson module. Additionally, the target device 106 can also encompass laptops, desktops, and/or servers, which in various examples can be characterized by their video and keyboard/mouse functionalities. In yet some examples, target device can include any of a number of different gaming devices or systems.

Various embodiments can include an integrated video and peripheral control apparatus or device 104, which in some examples can comprise a USB-based adapter designed to act as a bridge between the host computer 102 and the target device 106. This device 104 can be multi-functional in various embodiments: to the target device 106, it can emulate a monitor such as via a video and/or audio connection 108, a human interface device (HID) keyboard, an HID mouse, and in various examples can simulate other USB devices like a flash drive or serial communication port or the like, such as through a USB connection 110. To the host computer 102, the integrated video and peripheral control apparatus 104, in various embodiments, presents itself as a video device, an optional audio device, and one or several communication devices through a single USB 3.x (or faster speed) upstream connector 112. This arrangement in various embodiments can streamline the setup process, eliminating the need for multiple peripheral devices and cables.

Various embodiments can include a target device control application 114, which in some examples can include a piece of software residing on the host computer 102. In various embodiments, the target device control application 114 recognizes the integrated video and peripheral control apparatus 104 as a standard USB video device, audio device, and/or communication device. The software application 114 in some examples not only captures and displays the video from the target device 106 within a window or interface 116 displayed via the host computer 102, allowing for interactive zoom functionalities, but also plays the device's audio and translates the host computer's 102 mouse and keyboard inputs into corresponding controls on the target device 106. Further enhancing its utility, the software 114 in various embodiments can establish a virtual USB drive for convenient file transfer and can enable serial communication for tasks such as debugging, thereby significantly expanding the scope of interaction in some examples.

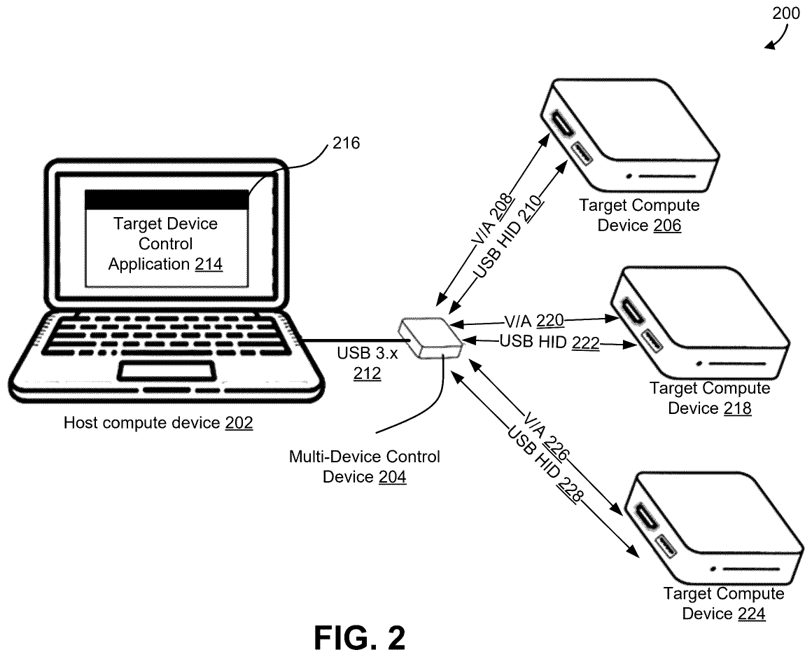

As illustrated in FIG. 2, various embodiments disclosed herein can simplify how users engage with one or more target devices 206, 218, 224 via a multi-device control device or apparatus 204. Unlike traditional KVM switches, which typically allow access to only one target device at a time, the multi-device control apparatus 204, in some embodiments, can provide simultaneous, seamless management and interaction with multiple target devices 206, 218, 224 concurrently. This apparatus 204 integrates multi-video inputs and USB peripheral controls, enabling a host computing device 202 to run a target device control application 214 to concurrently display and control multiple target devices 206, 218, 224. Target computing devices 206, 218, 224 may be multiple compact compute devices or general-purpose computing devices, including desktops and servers. By enabling simultaneous multi-device management, this apparatus substantially enhances flexibility and productivity compared to conventional KVM switch solutions.

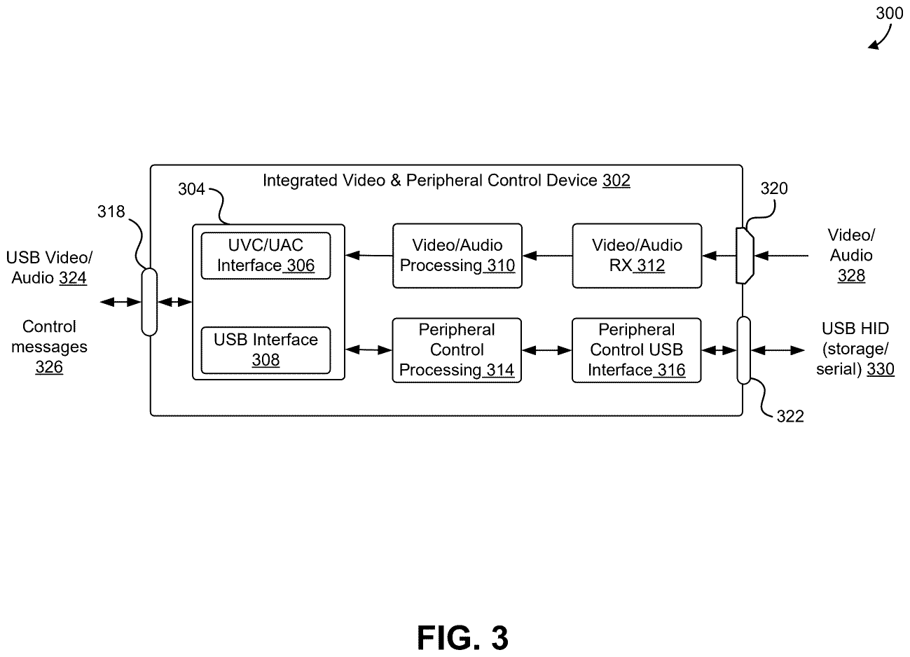

The integrated video and peripheral control apparatus in various embodiments includes an advanced hardware adapter designed to bridge the gap between compact compute devices and a host computer. An example architecture diagram 300 of an integrated video and peripheral control apparatus 302 will be described below in reference to FIG. 3. In various embodiments, integrated video and peripheral control apparatus 302 serves as a versatile intermediary, facilitating smooth integration and communication across devices.

On the host computing device interface side, the integrated video and peripheral control apparatus 302, in some examples, implements a composite USB device design through a single USB upstream connector 318, capable of transmitting data over a USB 3.x connection or faster speed, which can be desirable in some embodiments for maintaining the integrity of high-definition video and audio signals. The integrated video and peripheral control apparatus 302, in various examples, manifests or presents itself to the host computing device in one or more of the following capacities: as one or both of a standard USB video device through the USB Video Class (UVC) Interface 306 or USB audio device via the USB Audio Class (UAC) Interface 306, as a USB communication interface 308, which can range from a USB serial port to a broader USB Communication Device Class (CDC) devices or endpoints, or the like, such as through upstream interface 304 that communicates USB video/audio signals 324 (and device control messages 326) with a host computing device via connector 318.

In some cases, the integrated video and peripheral control apparatus 302 includes a USB serial communication interface 308 (which may be part of upstream interface 304) that establishes a bespoke or designated channel for the host computing device to dispatch peripheral control messages 326 to the integrated video and peripheral control apparatus 302. In some cases, control messages 326 can be processed to provide the direct manipulation of the target computing device. In some cases, the integrated video and peripheral control apparatus 302 includes a peripheral control processing unit 314, which may receive control messages 326 through USB interface 308 and convert or process the control messages 326 (e.g., including HID keyboard codes, mouse movements, and clicks) into standard HID report packets 330 for the target computing device's consumption.

In various embodiments, the integrated video and peripheral control device 302 includes two primary interfaces to the target computing device, a video/audio receiver (RX) 312 and a peripheral control interface, such as may be a peripheral control USB interface 316, which is connected to the peripheral control processing unit 314. In some examples, the video/(optional Audio) RX interface 312, may adopt the form of either HDMI or DisplayPort standards, which can be responsible for the reception of video signals and, if supported, audio signals 328 from the target computing device. The video/audio RX unit 312, in various embodiments, not only receives, but also may help enhancing the fidelity of transmitted signals. USB interface 308 may present the integrated video and peripheral control device 302 as a USB HID keyboard and a HID mouse to the target computing device, with capabilities in some embodiments as a USB mass storage class (MSC) device and/or a USB serial device, which can enable versatile storage and communication solutions in various examples.

In at least some scenarios, where USB MSC functionality is engaged, the peripheral control processing unit 314 can handle data read/write requests, mapping them to the corresponding block or bytes. This can allow the host computing device to offer a virtual disk to the target computing device, simulating a USB drive connection. Similarly, when USB serial functionality is activated, the integrated video and peripheral control apparatus 302 in various examples can serve as a USB CDC device to the target computing device, effectively emulating a USB serial connection that extends from the host computing device to the target computing device. In some cases, the video/audio processing unit 310 can convert the raw HDMI or DisplayPort signal into a USB-compatible format. In various examples, the video/audio processing unit 310 can process the video streams into widely accepted USB formats such as YUV422 (YUYV), YUV420 (NV12), or MJPEG, or the like, which can ensure compatibility and ease of streaming across a plethora of platforms.

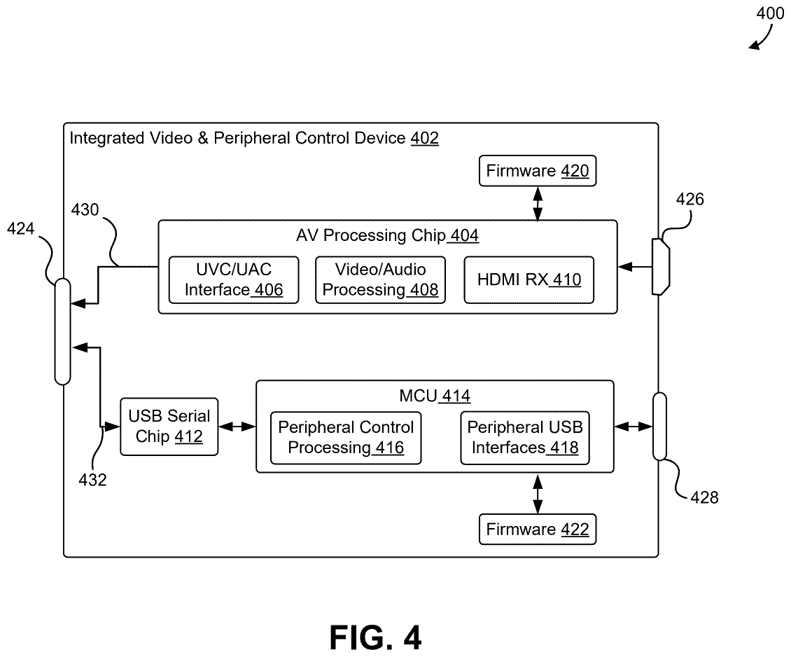

Various other implementation of an integrated video and peripheral control device apparatus are described below in reference to FIGS. 4-10. It should be appreciated that similarly named components share one or more aspects of similarly named components described above in reference to FIG. 3, and for the sake of brevity, will not be described again below.

One preferred embodiment of the integrated video and peripheral control apparatus is characterized by an efficient integration of components, tailored for optimal performance and cost-effectiveness. Another example physical layout or architecture 400 of an integrated video and peripheral control device 402 is depicted in FIG. 4, Architecture 400 outlines an arrangement of three interface connectors, which can serve a role in the device's operation. Various embodiments can comprise a USB 3.x (or faster speed) upstream connector 424 designed for rapid data transfer, connecting the apparatus to the host computing device. Such a super-speed link can be desirable in some embodiments for handling the substantial bandwidth requirements of video and audio data, as well as peripheral control messages, which can ensure responsive interaction between the host computing device and the integrated video and peripheral control device 402, in various examples.

On the side dedicated to the target computing device, the integrated video and peripheral control device 402 can feature two connectors: an HDMI connector (or Display Port) 426, (e.g., enabling the transmission of high-quality video and audio streams), and a USB connector 428 (e.g., supporting a minimal USB 1.1 or 2.0 standards, which can interface with the target computing device's peripheral ports in various embodiments).

The integrated video and peripheral control device 402 can include an AV processing chip or structure 404 that seamlessly integrates the HDMI RX 410, video/audio processing 408, and UVC/UAC interfaces 406 together. Such a chip 404 can provide for video and audio conversion process, transforming HDMI (or Display Port) signals into USB-compatible formats ready for the host computing device. Accompanied by a dedicated firmware chip 420 (e.g., residing in a flash), such a chip 404 in various embodiments can be responsible for defining the USB video and audio interface specifications, including vendor and product identifiers, and can ensure the correct formatting of the input/output video stream, the refresh rate and resolution parameters, such as based on the ROM and provided SDK functions from the chip manufacturer. Such firmware 420, in various embodiments, can provide for adaptability to various video and audio requirements, which can ensure that the apparatus remains compatible with a wide range of host computing device configurations and can in various embodiments deliver high-quality media streaming in line with the specifications of the connected devices.

Complementing this can be a USB serial chip 412, (e.g., a specialized component dedicated to managing USB communication with the host computing device). USB serial chip 412, in various examples, can ensure a robust and reliable transfer of control messages and serial data. In various examples, a microcontroller unit (MCU) can stand as the orchestrator of peripheral interactions in various examples, implementing peripheral control processing functionality 416 and/or peripheral USB interfaces 418. The MCU firmware 422 can be responsible for translating the control messages from the host computing device into the standardized protocol of USB HID devices in some embodiments.

In different use cases, there can be multiple ways to define the control messages exchanged between the host computing device and the MCU 414. It should be appreciated that the integrated video and peripheral control device 402 is compatible with and can implement a variety of specific control message formats, as are known in the art. In various embodiments, the host computing device application transmits detailed keycode information to the MCU 414, which may include a keyboard scancode or an operating system/application-defined keycode. The MCU firmware 422 may then be responsible for translating these keycodes into a HID Keyboard usage report, as specified in HID Usage Table Page 7 (Keyboard/Keypad Page, 0x07). Similarly, for mouse control, the host computing device application may send control messages that specify button actions and movement data. The MCU firmware 422 may translates these into a USB HID mouse usage report, following the definitions in HID Button Usage Page (0x09) for button presses and HID Generic Desktop Page (0x01) for movement data. In various implementations, the mouse movement data may be reported as relative changes (X, Y movement values) or absolute positioning, depending on the intended application. The HID report structure ensures compatibility with standard operating system input handling without requiring additional drivers.

Additionally, the MCU firmware 422, in various examples, can facilitate dynamic configuration of the integrated video and peripheral control device 402, enabling or disabling the USB mass storage and serial communication functionalities on the fly. This flexibility, in some embodiments, can ensure that the integrated video and peripheral control device 402 can cater to the evolving needs of users, allowing for easy file transfers through a virtual disk or direct device communication via serial interfaces.

Unlike implementations that rely on specialized Serial-to-HID ICs, such as dedicated UART-to-HID Keyboard/Mouse chips, the MCU 414 and associated firmware 422 approach, in various embodiments, provides greater flexibility and extensibility. A specialized IC typically operates with a fixed, manufacturer-defined protocol, limiting customization and expansion beyond standard keyboard and mouse functions. In contrast, the MCU-based approach allows for custom communication protocols between the host computing device and the firmware, enabling additional features beyond standard HID input. This can include, but is not limited to, device-specific control messaging, dynamic feature reconfiguration, and enhanced interaction with external peripherals. Such an approach in various embodiments can offer greater adaptability, ensuring that the integrated video and peripheral control device 402 is not restricted by the constraints of a dedicated HID translation chip. By integrating these capabilities in various embodiments the MCU firmware 422 can effectively extend the host computing device's functionality, making it a powerful hub for device interaction and control.

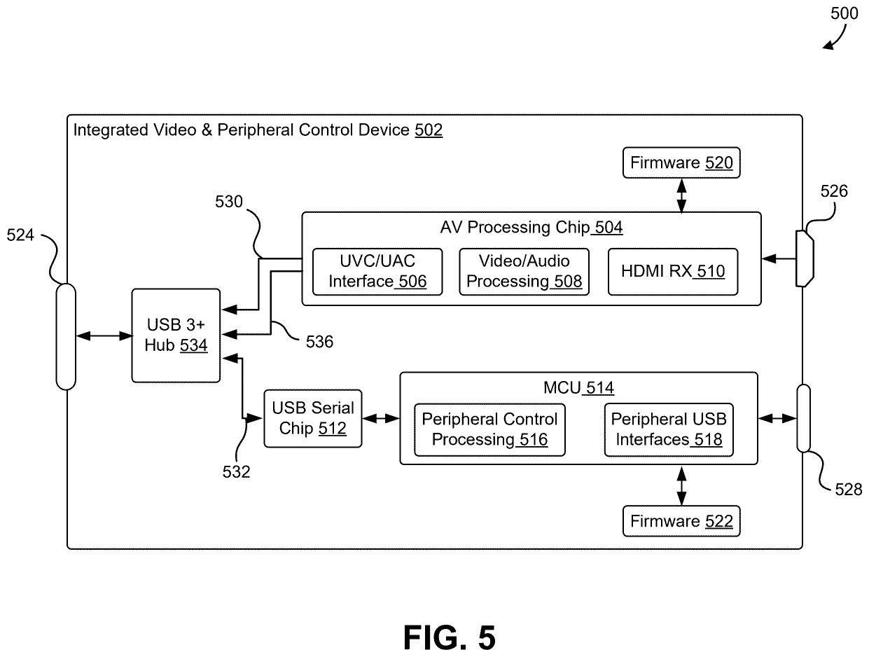

An alternative design for an integrated video and peripheral control device 502 that incorporates a USB 3+ hub 34, is illustrated in architecture 500 of FIG. 5. In this design, the USB 3+hub 534 serves as an intermediary between the integrated video and peripheral control device 502 and the host computing device, facilitating the transmission of USB 3+ video/audio signals 530, USB 2 video/audio signals 536, and USB 2 control communication 532 with the MCU 514 and AV processing chip 504. This design may be used because many USB 3+ video capture/processing chips 504 expose both a USB 3 interface and a USB 2 interface. Depending on whether the host computing device is connected via a USB 3 or USB 2 port or cable, only one of these interfaces is active at any given time. Since there are three distinct signal channels-USB 3.x video/audio 530, USB 2 video/audio 536, and USB 2 for control 532, the USB 3+ hub may manage multiplexing these signals to the host computing device. While this approach enables compatibility with both USB 3 and USB 2 hosts, it may introduce system complexity by requiring an additional USB 3+ mhub chip or structure 534. The addition of a USB 3+ hub 534 may increase design complexity, power consumption, and cost, making it a less efficient solution for streamlined implementations.

In contrast, in other use cases, such as where video and/or audio signals will not be in USB 3+ format, other designs may eliminate the need for an explicit USB 3+ hub, significantly simplifying the system architecture. This is possible due to the unique characteristics of USB 3.x connectors, which inherently carry both USB 3.x signal lines and USB 2.0 signal lines within the same physical connector. Effectively, this structure functions as a simple two-port hub, allowing simultaneous transport of one channel of USB 3.x data and one channel of USB 2.0 data. By leveraging this feature, the some designs remove the dependency on an explicit USB 3+ hub 534, reducing system complexity while maintaining super-speed video data transmission. Such an implementation can be desirable for its cost-efficiency, and can leverage components such as AV processing chips 504, serial communication modules 512, and MCUs 514. Various embodiments can provide a balance between performance and cost, making an ideal solution within the current technological landscape.

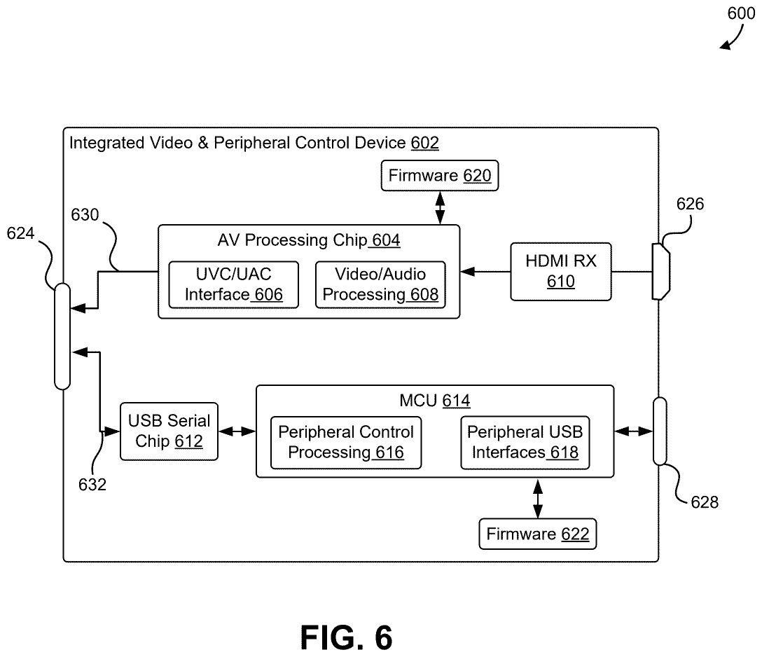

Another example implementation of the integrated video and peripheral control device 602 is illustrated as architecture 600 in FIG. 6. In this variation, the design distinguishes itself from some embodiments (e.g., the example embodiment discussed above) by assigning HDMI RX functionality 610 its own dedicated chip, separate from the AV processing chip 604. This modular approach, in some embodiments, can allow for specialized handling of HDMI signals by the HDMI RX 604 before they enter the AV processing stage 604. By isolating the HDMI reception, such a design in some examples can offer improved performance in HDMI signal handling or flexibility in selecting specific HDMI RX chips 610 based on different performance or feature requirements.

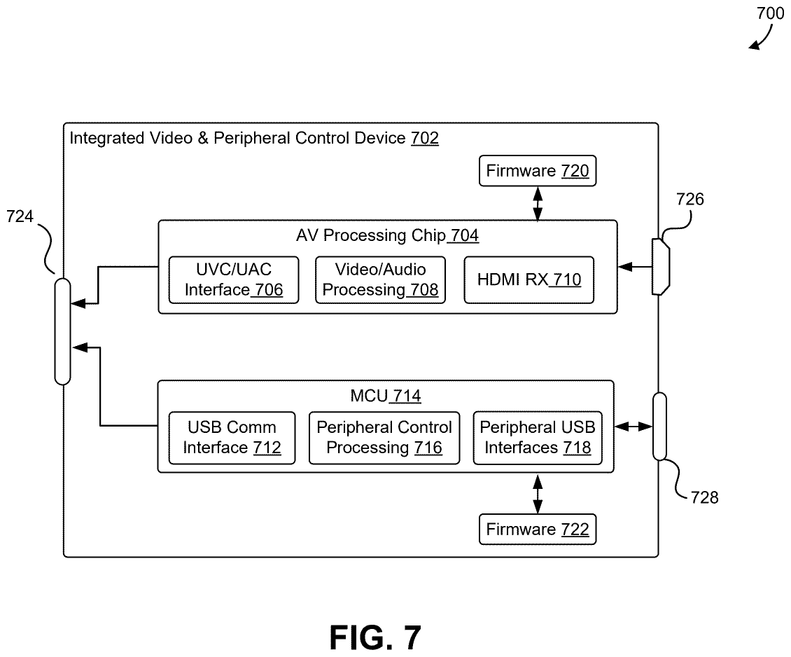

Another example implementation of the integrated video and peripheral control device 702 is illustrated as architecture 700 in FIG. 7. This example configuration includes an expanded MCU 714 including an integrating a host USB communication interface 712, peripheral control processing 716, and the peripheral USB interface 718 all within a single chip. This change can simplify the internal architecture by reducing the number of separate chips required and can simplify the manufacturing process. Such a design in some examples can provide for internal communication efficiency, as the integrated MCU 714 can directly manage peripheral control messages and communication with the host computing device.

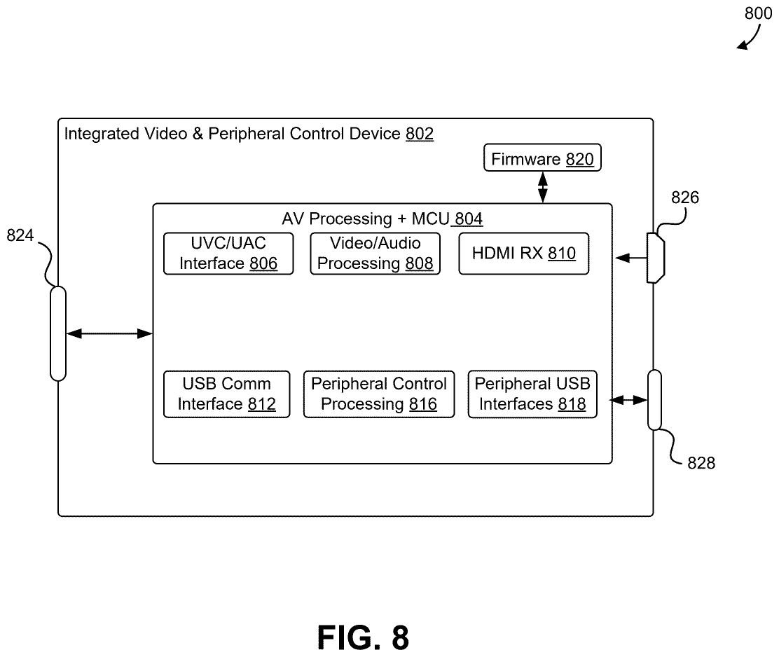

Another example implementation of the integrated video and peripheral control device 802 is illustrated as architecture 800 in FIG. 8. In this example implementation, all functionality can be consolidated, including AV processing 808, peripheral control processing 816, MCU, USB interfaces 806, 812, 818, and HDMI RX 810 into a single chip, such as may be implemented by one or more processors connected to memory. Such an integrated system in various embodiments necessitates only one block of firmware 820, which can greatly simplify the development of the integrated video and peripheral control device, in some examples. Such an all-in-one design in various embodiments can lead to a more compact form factor and can lower production costs at scale.

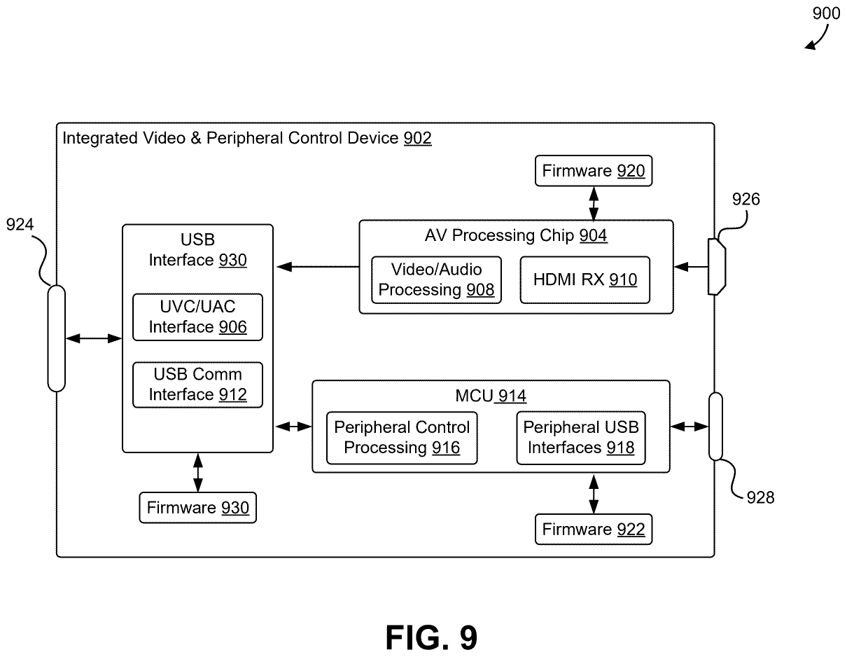

Another example implementation of the integrated video and peripheral control device 902 is illustrated as architecture 900 in FIG. 9. This example design 900 can be configured to unify some or all host-facing USB interfaces 906 and 912 into a single USB interface 930, such as may be implemented by a single chip 904. In contrast, in various embodiments, AV processing 908 and HDMI RX 910 can be contained within a second chip 904, and the peripheral control functionalities 916 and interfaces 918 within a third chip or MCU 914. Each chip can be programmed by its dedicated firmware 920, 922, 930, respectively, allowing in some examples for targeted optimizations and easier updates and/or fault isolation within each functional domain.

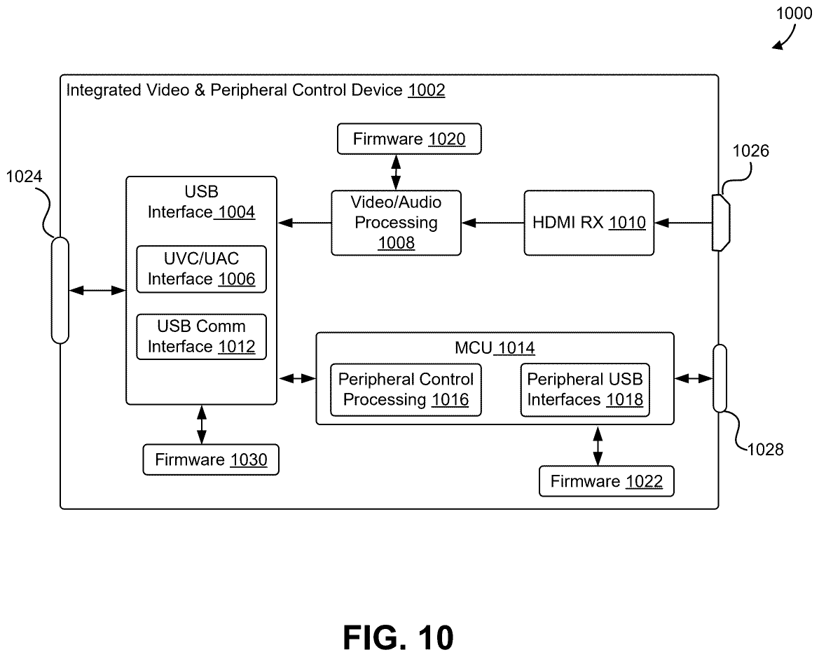

Another example implementation of the integrated video and peripheral control device 1002 is illustrated as architecture 1000 in FIG. 10. Building on the example structure of integrated video and peripheral control device 902, this architecture 1000 can be configured to further separate AV processing 1008 and HDMI RX 1010 on separate chips. This division may be advantageous in some embodiments for choosing specialized chips for each task or employing widely accessible, standard components. Moreover, this configuration in some embodiments can allow for utilizing a Field-Programmable Gate Array (FPGA) to execute specific functions, like those of the AV processing chip 1008, which can offer tailored performance and flexibility in various examples.

Each of these example alternative implementations can provide a different approach to achieving various core functionality of the integrated video and peripheral control device in various embodiments, which can reflect different potential trade-offs between integration and modularity, performance, manufacturing complexity, and costs. However, these example embodiments should not be construed as being limiting on the wide variety of additional embodiments that are within the scope and spirit of the present disclosure. Additionally, in some examples, elements of these examples can be suitably combined in further embodiments or various elements can be specifically absent.

In various embodiments disclosed herein, the previously described single-device integrated video and peripheral control device or apparatus can be modularized, serving as a single-device control module. such modules can be leveraged to construct an advanced multi-device control device of apparatus with a single USB 3.x (or faster speed) upstream connector to the host computing device, significantly simplifying the capability of managing multiple target computing device s simultaneously.

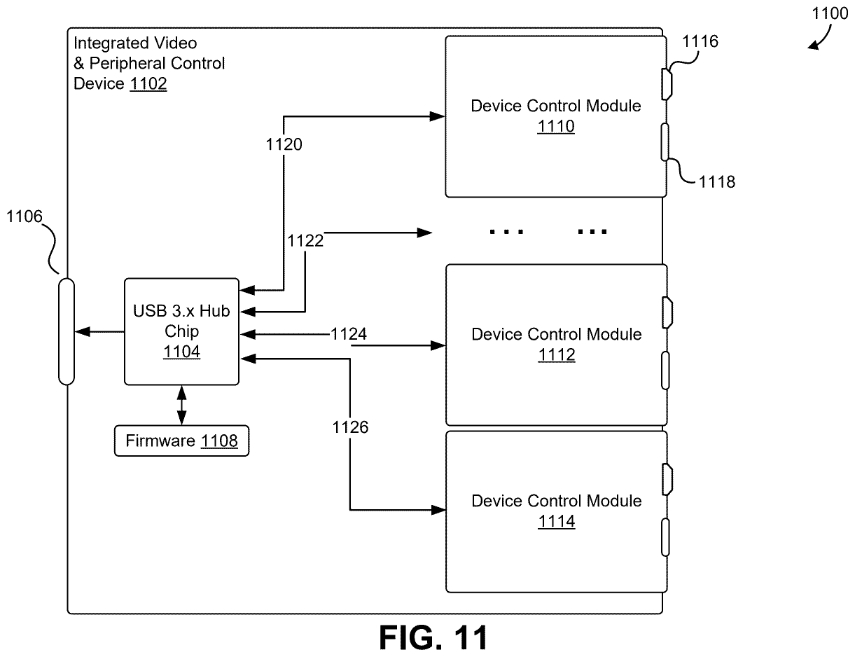

One implementation for achieving optimal signal integrity and operational reliability involves integrating a USB hub chip and multiple single-device control modules onto a single printed circuit board (PCB). By consolidating these components onto one PCB, embodiments can ensure minimal signal degradation and increased reliability through reduced physical connectors and shorter trace lengths. FIG. 11 illustrates an example diagram 1100 of this implementation of a multi-device integrated video and peripheral control device 1102, which includes an integrated USB 3.x (or faster speed) hub functionality/chip 1104, which can communicate with a host computing device through a USB 3.0 or greater port 1106, alongside and connected to multiple single-device control modules 1110, 1112, 1114 within a single-board solution.

In this implementation, the selected hub chip 1104 supports USB 3.x or faster standards, and provides two or more (e.g., four) USB 3.x downstream ports. The USB hub may be programmed via firmware 1108, adapted to enable identification and routing of different signals to different target devices. Each USB downstream port/connection 1120, 1122, 1124, 1126 from the internal hub 1104 directly connects to an individual single-device control module 1110, 1112, 1114. In some cases, each single-device control module 1110, 1112, 1114 may include ports, such as an HDMI/DisplayPort 1116 and a USB port 1118 for communicating with individual target computing devices. While a USB hub 1104 supporting speeds of at least 10 Gb/s is preferred for full video bandwidth and high-quality peripheral control, embodiments using 5 Gb/s or other bandwidth hubs are also feasible, although each connected single-device control module would experience proportionally reduced bandwidth.

Due to this architectural arrangement, the host computing device (e.g., through an application as described in greater detail below) can detect and interact with each single-device control module 1110, 1112, and 1114 independently. For instance, in an embodiment where the internal USB hub 1104 has four ports, the host computing device would recognize four independent USB Video Class (UVC) devices. Additionally, the host would identify four separate serial communication devices dedicated to transmitting control messages, enabling precise and independent management of each connected target computing device. Furthermore, this architecture allows the existing single-device control host application to be easily modified to support multiple device controls.

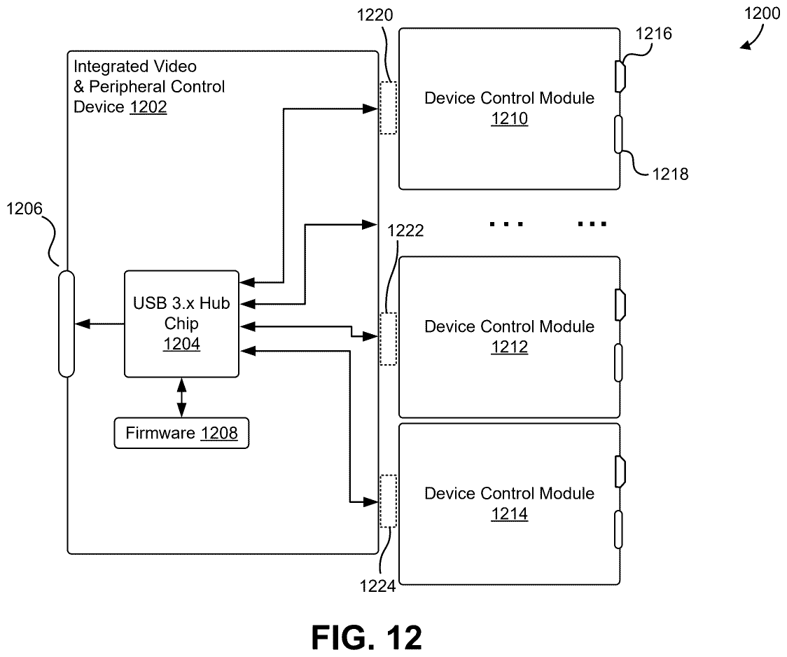

In an alternative implementation, embodiments can promote module reusability by enabling the previously described single-device control board to serve as a hardware board module with minimal modifications. This approach supports a more modular architecture. To facilitate this modular design, a separate USB hub board can be created, having similar functionalities as the USB hub 1104 described above in reference to FIG. 11. FIG. 12 illustrates this alternative implementation 1200, and includes a multi-device integrated video and peripheral control device or hub board 1202, which includes a USB hub chip/component 1204 connected to any number of connectors 1220, 1222, 1224 (represented by dotted boxes) which may then connect to separate device control module(s) 1210, 1212, 1214. The hub board 1202 includes internal port connectors specifically designed to interface with each single-device board module 1210, 1212, 1214.

The primary advantage of this implementation is the substantial reuse of existing hardware modules. Additionally, it provides flexibility to create various stackable form factors or different physical configurations, depending on how the individual modules are physically arranged or stacked together.

It should be appreciated, as described herein, the various components described in relation to the integrated video and peripheral control device of FIGS. 1-12 may implemented in a number of ways, including by one or more processors, connected to memory storing instructions, that when executed, causes the one or more processors to perform various operations, including those described herein In some cases, the various implementations of references to firmware may contain some or all of these instructions. In other cases, various other memory, such as may be contained in distinct memory devices or as part of packaged integrated circuits, micro-controllers, different chips, etc., as described above, may contain some or all of these instructions. Similarly, reference to one or more processors includes reference to these specific implementations of various types of processors, whether separate or integrated in integrated circuits, microcontrollers, etc.

In some examples, other connectors or interfaces may be utilized by the integrated video and peripheral control device or apparatus, as described herein, to communicate with one or more of a target computing device and/or a host computing device. In some cases, various wireless or other wired interfaces may be utilized in addition to or alternative to USB, USB 3.0 or greater, and/or HDMI/DisplayPort. These wired connections may provide a reliable wired connection with high-speed data transfer. In some cases, the integrated video and peripheral control device may utilize any of various other communication interfaces to ensure compatibility and efficient data transfer, including Bluetooth, Wi-Fi, Zigbee, and NFC, as a few non-limiting examples. In some cases, these alternatives may offer distinct advantages: Bluetooth may offer high bandwidth, wide compatibility, interference resistance, for short distances, among others; Wi-Fi may enable wireless communication with extended range and bandwidth; Zigbee may offer low-power, short-range connectivity ideal for energy-efficient applications; and NFC may facilitate quick, short-range wireless communication suitable for rapid data exchange and device pairing. In some cases, by utilizing and/or incorporating these diverse communication options, the integrated video and peripheral control device may ensure flexibility and adaptability in various computing environments, enhancing the seamless integration and emulation of peripheral devices. In some cases, one or more wireless technologies or interfaces may be utilized in place of one or more of the upstream or downstream interfaces. In some cases, one or more wireless technologies or interfaces may be utilized in addition to one or more of the wired upstream or downstream interfaces (where if two different communication interfaces are utilized for one of these connectors or interfaces, one may be designated the primary and one may be used for backup in case the primary is not determined to be suitable for a specific application).

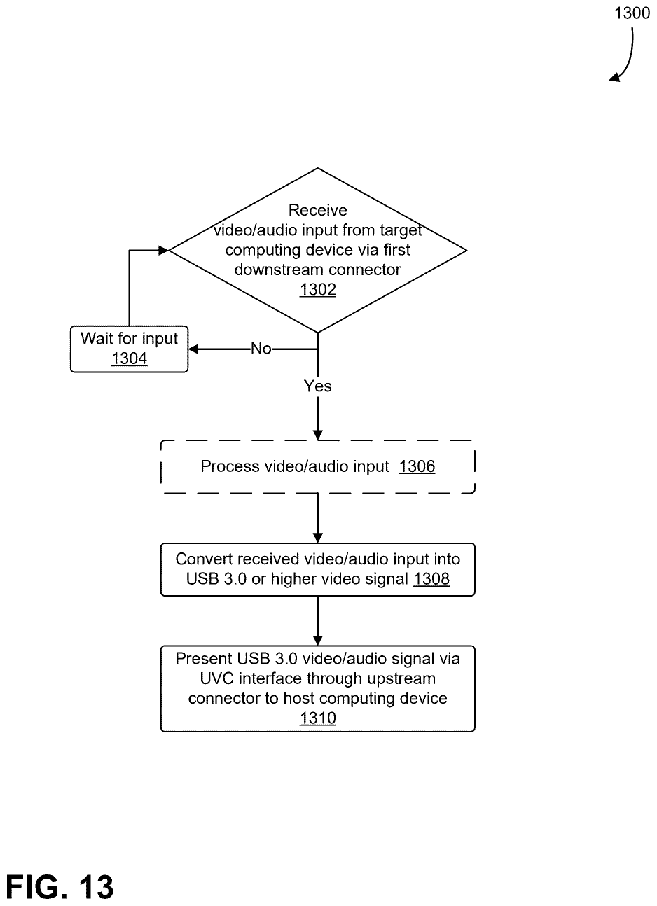

FIG. 13 illustrates an example process 1300 of converting video/audio data that may be performed by various components of the integrated video and peripheral control device described above in reference to any of FIGS. 1-12. As illustrated in FIG. 13, and as used herein, dotted lines in process flow diagrams indicate optional operations, such that the process may be performed with or in some cases without the indicated operation.

As illustrated, process 1300 may include an integrated video and peripheral control device receiving audio and/or video input from a target computing device, such as through a downstream connector, at operation 1302. In some cases, as described above, the downstream connector may include an HDMI or DisplayPort connection. In some cases, the integrated video and peripheral control device may wait for such an input before initiating process 1300, such as illustrated by the loop from operation 1302 to operation 1304 labeled wait for an input, and then back to operation 1302, until an input is detected. Upon detection of a video or audio input, at operation 1302, process 1300 may proceed to operation 1306, in which the video and/or audio input may be processed or modified in one or various ways. AS illustrated operation 1306 may be optional. In some cases, operation 1306 may include decoding, filtering, or enhancing the input signal(s) to prepare them for conversion.

Next, at operation 1308, the integrated video and peripheral control device may convert the video and/or audio input into a USB 3.0 or higher video/audio signal. This conversion ensures that the data is compatible with modern USB interfaces, allowing for high-speed transmission and reduced latency, such that the converted video/audio signal(s) can be consumed and rendered by a host computing device.

Next, at operation 1310, the integrated video and peripheral control device may present the video/audio signal(s) via a Universal Video Class (UVC) or interface Universal Audio Class (UAC) interface to the host computing device. The signal(s) may be transmitted through an upstream connector, such as a USB 3.0 or greater connection or interface, to the host computing device. This step ensures seamless integration with the host device, enabling it to receive and utilize the video/audio data effectively. As described above, the upstream connector may be a USB 3.0 or greater connection or other connection that supports a similar standard that may be compatible with a host computing device. In some aspects, upon completion of operation 1310, process 1300 may loop back and begin again at operation 1302.

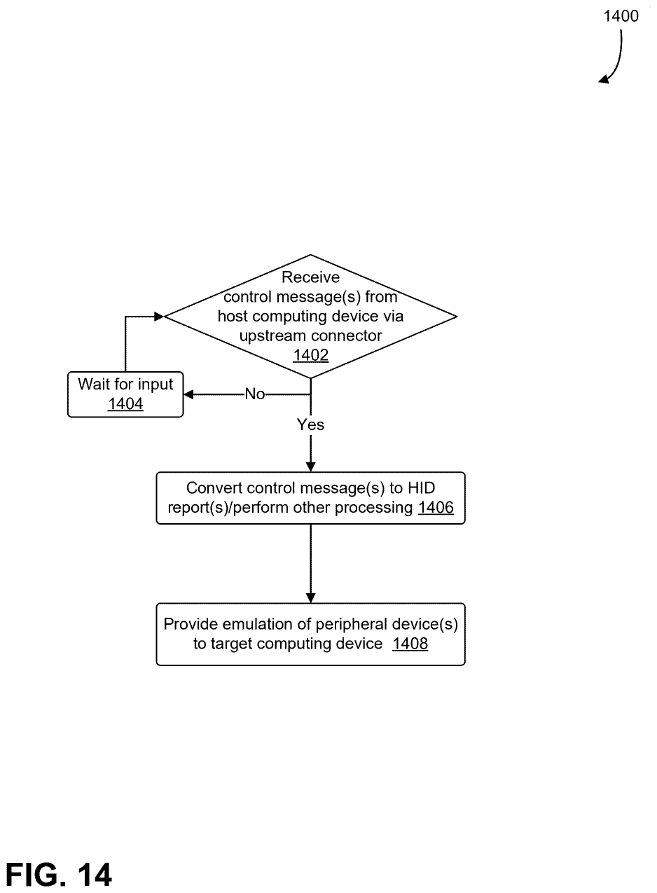

FIG. 14 illustrates an example process 1400 of converting control messages of peripheral devices that may be performed by various components of the integrated video and peripheral control device described above in reference to any of FIGS. 1-12.

As illustrated, process 1400 may include an integrated video and peripheral control device receiving one or more control messages from a host computing device, such as through an upstream connector, at operation 1402. The control messages, as described above, may originate from any of number of different peripheral control devices (e.g., a keyboard, mouse, optical interface, game controller, etc.). In various examples, an application being performed on or by the host computing device, such as a target device control application described herein, may modify, convert, or otherwise change the raw input data received from one or more peripheral control devices into a format that is usable by the integrated video and peripheral control device. In some cases, as described above, the upstream connector may include a USB 3.0 or greater connection interface, or other interface/connection, that may support multiple logical channels for control messages and video/audio data. In some cases, the integrated video and peripheral control device may wait for such an input before initiating process 1400, such as illustrated by the loop from operation 1402 to operation 1404 labeled wait for an input, and then back to operation 1402, until an input is detected.

Upon detection of one or more control messages, at operation 1402, process 1400 may proceed to operation 1406, in which the integrated video and peripheral control device may convert the control message(s) into Human Interface Device (HID) reports/messages or performing other necessary processing. This step may involve decoding, filtering, or enhancing the messages to enable the integrated video and peripheral control device to accurately emulate the peripheral control device inputs/control messages to control/modify the target computing device.

Next, at operation 1408, the integrated video and peripheral control device may provide the processed control messages/converted HID messages or reports to emulate the peripheral devices to the target computing device, such as through a second downstream connector. In some cases, the second downstream connector may be a USB 1.1, USB 2.0 or other connector or interface that supports communication of control messages to a given target computing device. This step may ensures seamless integration with the target device, enabling it to receive and utilize the emulated actions effectively. In some aspects, upon completion of operation 1408, process 1400 may loop back and begin again at operation 1402.

In some embodiments, both of processes 1300 and 1400, and variations thereof, may be performed by an integrated video and peripheral control device, such as any of the example devices described above in reference to any of FIGS. 1-12. In some examples, the integrated video and peripheral control device may perform one or more operations of either process 1300 or 1400 concurrently, simultaneously, or at different times. In some aspects, the integrated video and peripheral control device may perform process 1300 upon receiving audio of video data from a target device, and may perform process 1400 upon receiving various data from a host computing device. In some examples, such as in the multi-device integrated video and peripheral control device 1000 and/or 1100 described above in reference to FIGS. 10 and 11, one or more processors may perform multiple instances of process 1300 and/or 1400 for a given target computing device/instance of a target device control application operating on a host computing device concurrently or simultaneously.

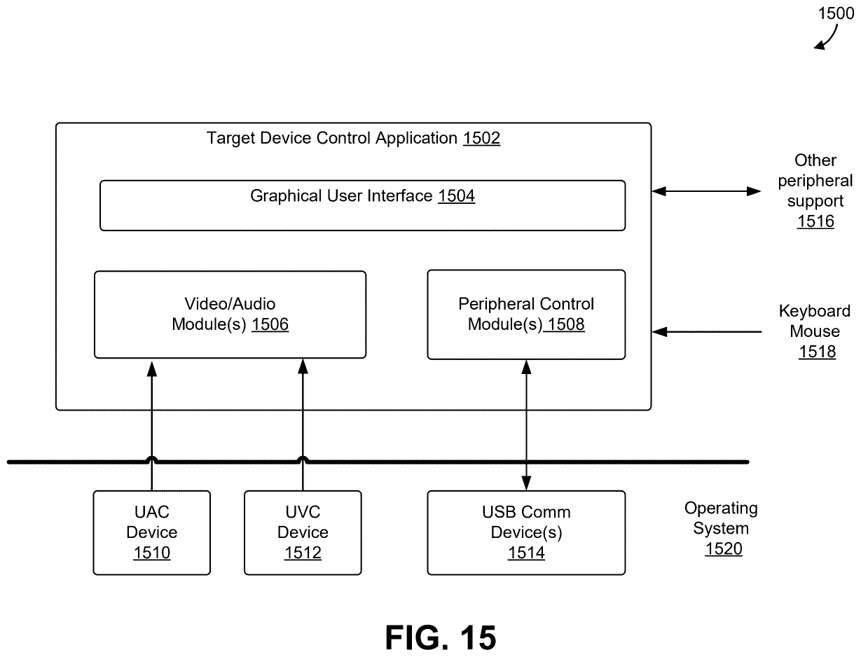

As described above, the various implementation of an integrated video and peripheral control device including the multi-device versions, may interact with a host computing device via a target device control application operating or running on the host computing device. An example architecture 1500 for a target computing device control application 1502 is illustrated in FIG. 15. The target computing device control application 1502 delineates a modular framework that, in some embodiments, can be designed to facilitate comprehensive control over a connected target computing device. This framework can comprise software components including one or more of: the graphical user interface (GUI) 1504, video/audio modules 1506, and peripheral control modules 1508, and in some embodiments one or more of such can interface with the standard operating system's device and communication protocols, which in various examples can deliver a seamless user experience.

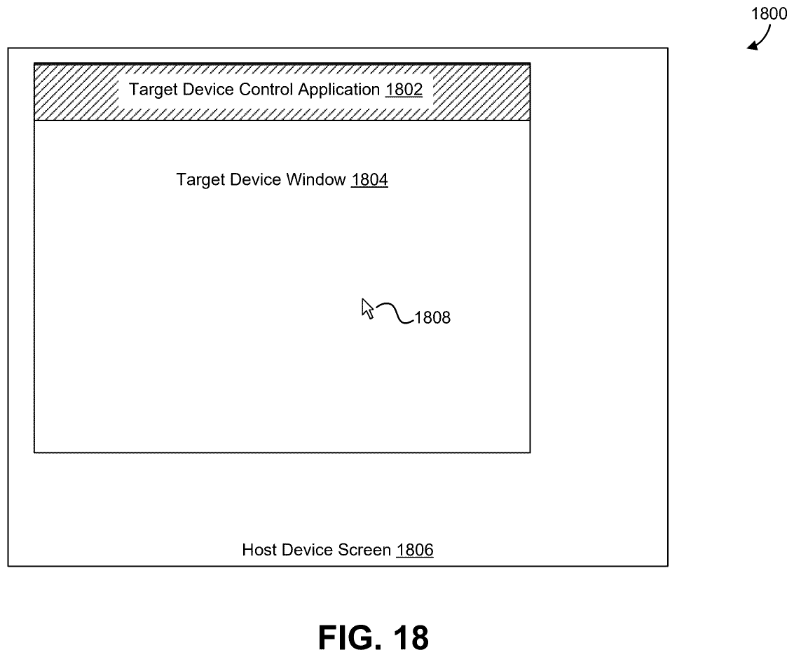

The GUI 1504 in some embodiments can serve as the primary interface through which users interact with the application. In various examples, it can provide a visual representation of the target computing device's video and audio outputs and can offer intuitive control mechanisms. Example GUIs 1504 will be described below in reference to FIGS. 18-20.

Video/audio modules 1506 and peripheral control modules 1508 can constitute the core processing units of the application 1504 in some embodiments. The video/audio modules 1506 can be tasked with the handling of media streams, which in various examples can ensure the smooth playback of video and audio from the target computing device. Because audio is optional in some cases, the software audio module 1506 can also be optional, depending on whether the hardware apparatus provides the audio functionality.

The peripheral control modules 1508 can be configured for translating user inputs, such as by intercepting keyboard and mouse events (or other control device events) 1518 from the host computing device and reformatting these signals for transmission through the USB com device(s) 1514. In some cases, the peripheral control modules 1508 can be configured for managing other types of peripheral controls as necessary 1516.

The target computing device control application 1502 can be engineered to be cross-platform, with versions tailored for Windows, Linux, and MacOS or the like. This approach in various examples can ensure wide compatibility and accessibility, allowing users across various computing environments to leverage the powerful capabilities of the application. Installation packages in some embodiments can be designed for each operating system, which can ensure that regardless of the platform, the user experience remains consistent, and the functionality of the apparatus is fully realized.

In various embodiments, video/audio modules 1506 within the target computing device control application 1504 can provide functionality for the real-time processing and rendering of media streams. These modules in some examples can work in tandem with standard UVC (USB Video Class) and UAC (USB Audio Class) devices 1510, 1512 that the operating system 1520 of the host computing device identifies/recognizes and supports. The intricacies of capturing these media streams can vary significantly across different operating systems in various examples. To create a unified capture mechanism that offers cross-platform compatibility, frameworks such as Simple Direct Media Layer (SDL) can be utilized in some embodiments. The choice of capture mechanism may affect the application's efficiency and responsiveness. Applications can also adopt platform-specific capture mechanisms such as Media Foundation in Windows and V4L2 in Linux.

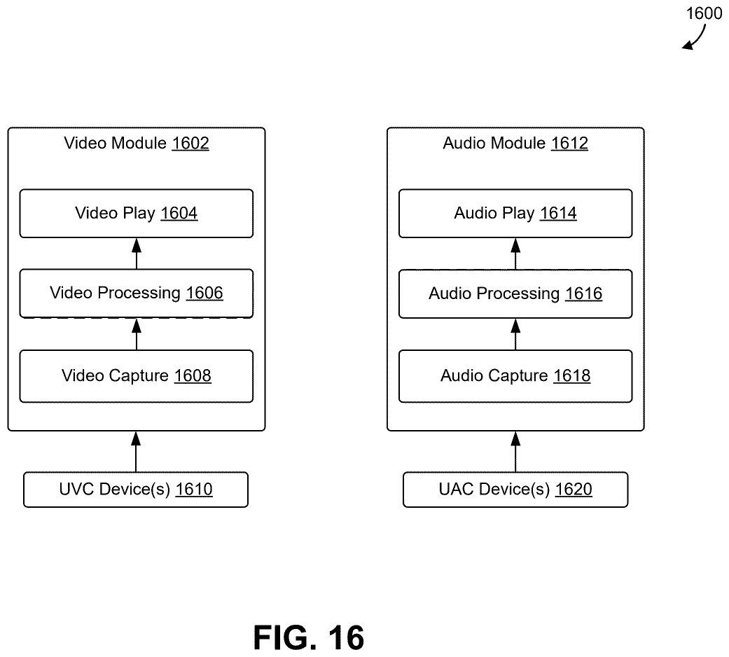

More detailed examples of the video/audio module(s) 1506 are illustrated in diagram 1600 of FIG. 16. As illustrated, a video module 1602 and audio module 1612 may be separate to perform different operations on different types of data. In some cases, once the video data is captured, at operation 1608 by the video module 1602, such as may be obtained from the UVC device 1610 (of the integrated video and peripheral control device), the video processing sub-module 1606 within the video module 1602 may perform format conversion, which can be desirable in some examples for compatibility with the video play engine implemented by the host computing device. In various embodiments, video can be captured in YUYV, NV12, or other raw formats and can be converted into an RGB format suit-able for playback. Achieving high-performance video processing in some embodiments can include the use of GPUs and specialized CPU extensions/instructions that can handle intense computational tasks with greater speed and lower latency. In some cases, video processing 1606 may include upsampling video and/or performing other operations on the video to condition the video data, improve quality, reduce noise, etc., prior to playing or rending the video at operation 1604 via one or more display devices forming part of or connected to or in communication with the host computing device.

Similar to the video module 1602, the audio module 1612 may obtain audio data from a UAC device 1620 (of the integrated video and peripheral control device), via audio capture operation 1618. The audio data may then be processed, such as may include upsampling, reducing./removing noise, converting to a different format, and so on. The processed audio data may then be played at operation 1614 via the host computing device/audio device connected to or in communication with the host computing device.

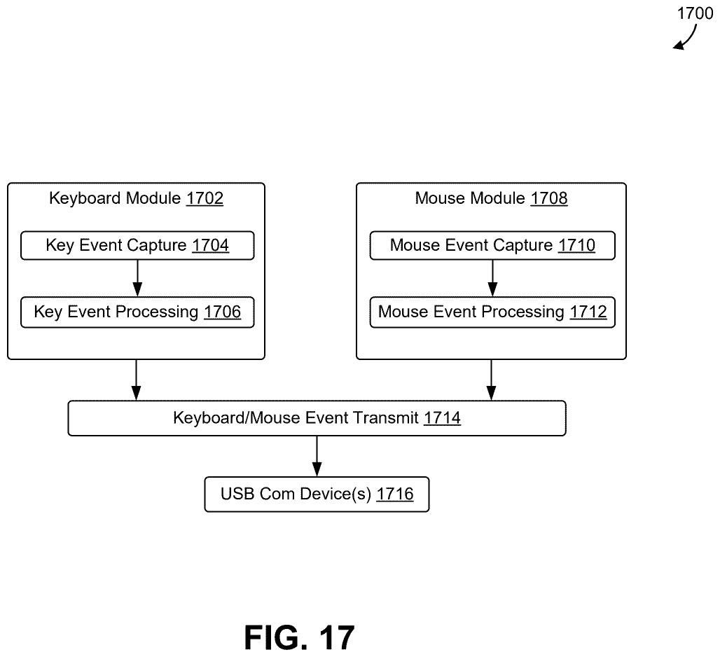

More detailed examples of the peripheral module(s) 1508 are illustrated in diagram 1700 of FIG. 17. Peripheral Control Modules of various embodiments can be designed to seamlessly capture and translate user input from the peripheral controls connected to or that form part of the host computing device into standardized HID commands. This standardization can ensure that the apparatus's firmware can interpret the commands without needing to manage various keyboard and mouse message formats, thereby simplifying the firmware complexity, and enhancing compatibility. Example peripheral control modules, including a keyboard module 1702 and a mouse module 1708 are illustrated in diagram 1700. It should be appreciated, however, that other peripheral control devices may have a corresponding module to capture and process input data originating from these peripheral control devices. It should also be appreciated that while the HID standard is utilized for its wide adopting, other standards or messaging protocols may be similarly used and to a similar effect.

As described above, there can be multiple ways to define the control messages exchanged between the host computing device and the integrated video and peripheral control device. The specific control message format may vary, but the underlying principles remain the same across implementations. Regardless of format, the target device control application operating on the host computing device may transmits keycode information, which the integrated video and peripheral control device may translates into standard HID reports for keyboard and mouse input. This ensures compatibility with standard HID input handling by the target computing device.

As illustrated, a keyboard module 1702 may capture one or more key events from a keyboard device connected to the host computing device, at operation 1704. The key event or events may then be processed at operation 1706, such as to identify the signal received from the keyboard and convert it into an instruction to perform relative to the target computing device (e.g., different letters, numbers, etc.). The processed key event may then be communicated to a common event transmit mechanism 1714 that unifies the handling of some or all control messages directed to the integrated video and peripheral control device.

Similarly, a mouse module 1708 may capture one or more mouse events (movement of cursor, clicks one or more buttons, etc.) from a mouse device connected to the host computing device, at operation 1710. The mouse event or events may then be processed at operation 1712, such as to identify the signal received from the mouse and convert it into an instruction to perform relative to the target computing device (e.g., movement of cursor, selection of one or more items, etc.). The processed mouse event may then be communicated to the common event transmit mechanism 1714 that unifies the handling of some or all control messages directed to the integrated video and peripheral control device.

The consolidation of control key and mouse events into unified format control messages, in some examples, can streamline the communication process and can reinforce the robustness of the interaction between the host computing device and the integrated video and peripheral control device. The application in various embodiments can include modules to manage other types of peripheral controls, such as those necessary or desirable for enabling and utilizing a virtual disk. When activated, this can allow the host computing device to mount a virtual USB drive to the target computing device in various embodiments. Additionally, in some examples, terminal read/write capabilities can enable the transmission of data through a pipe, which may facilitate a virtual serial connection (TX/RX) with the target computing device. In some embodiments, such features are optional and/or can be dynamically enabled or disabled as required by the user, which can add a layer of customization and flexibility to the application's functionality in various examples. These features can provide application versatility, making it a powerful tool for various use cases and user preferences.

FIG. 18 illustrates an example view 1800 of a GUI provided by a target device control application 1802, such as may be an example of target device control application 1502, as described above in reference to FIG. 15. While GUI 1800 as illustrated does not include many visual features, it should be appreciated that GUI 1800 can be crafted or modified to deliver a user-friendly experience with any number of various visual controls, selection options represented visually by an application area 1802 of a host device screen or display 1806. The GUI 1800 can include a main window 1804 which may be sized and/or modified to encompass part or all of screen 1806, which can render window 1804 representing a visual interface to directly interact with the target computing device. This replicated display, as visualized via application area 1802 in various embodiments can allow users to view and interact with the target computing device as if it were directly in front of them/operating as part of the host computing device.

In various embodiments, the GUI 1800 can have the ability to adjust the view of the target computing device's screen. For example, in some embodiments, users can zoom in or zoom out for a closer look or the broader picture. Moreover, the GUI 1800 in various embodiments supports a full-screen mode, which can be particularly useful in some examples when the user needs to focus exclusively on the target computing device, replicating its display across the entire screen of the host computing device, just as a user would interact with an application provided by the host computing device.

To ensure a consistent user experience across different operating systems—Windows, Linux, and macOS—a common GUI framework may be employed in various embodiments. This framework, in some examples, can allow the same interactions and visual elements to be presented to the user regardless of the underlying operating system. The choice of which GUI framework to utilize, or whether to use OS-specific interfaces, can be selected to balance the application's requirements with the desired uniformity and the development resources available. Whether through a framework like imGui, or Qt, which can be desirable for its cross-platform capabilities in some examples, or through native interfaces designed for each operating system, the goal of various embodiments can be to provide a seamless and cohesive experience that feels native to the user's computing environment.

When a multi-device control apparatus, such as any of the examples 1102 and 1202 described above in reference to FIGS. 11 and 12, is connected to a host computing device, the system/target device control application may recognize each individual target computing device as a separate USB video class (UVC) and USB audio class (UAC) device, along with a corresponding USB communication device. This enables independent access and control over multiple target computing devices without additional complexity on the hardware side.

The single-device target computing device control application, such as example applications 1502, 1802 described above in reference to FIGS. 15 and 18, can be modified to support multiple target computing devices. The primary changes involve handling multiple device instances rather than a single instance, while maintaining the core architecture and communication methods.

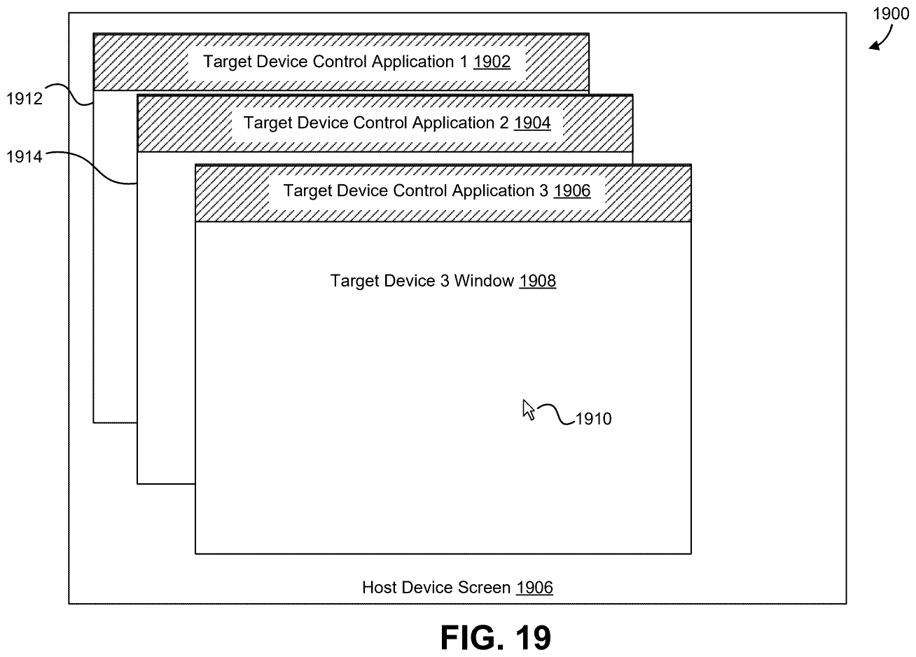

In some embodiments, the application can be configured to allow multiple instances of the application interface to be launched, with each instance dedicated to controlling a single target computing device, such as illustrated in the example GUI 1900 of FIG. 19. As illustrated in GUI 1900, each target device control application instance 1902, 1904 1906 may define its own individual window or area 1912, 1914, 1908. This allows users to operate multiple target computing devices independently, each having its own respective window 1908, 1912, 1914 providing a straightforward and isolated control approach, whereby interaction or selection via mouse cursor 1910 may enable separate control of one of the target computing devices at a given time, similar to other applications running on host computing device.

In some cases, the application can assign a identifier (e.g., a unique identifier) to each detected target computing device, such as based on the USB port number and/or its physical connection location. These identifiers, such as 1, 2, 3, and 4, (or in other implementations, any alpha numeric identifier of any length) can be displayed within the application UI to help users easily distinguish and manage multiple connected devices. The application may also use these or other identifiers to map data from and to the different target devices, to enable correct routing of peripheral controls and video and audio data to and from the correct target computing device. In some cases, the identifier displayed in UI 1900 (e.g., a user customizable identifier) may be different from an identifier (e.g., a unique alpha numeric identifier) used in the communication of data with the integrated video and peripheral control device.

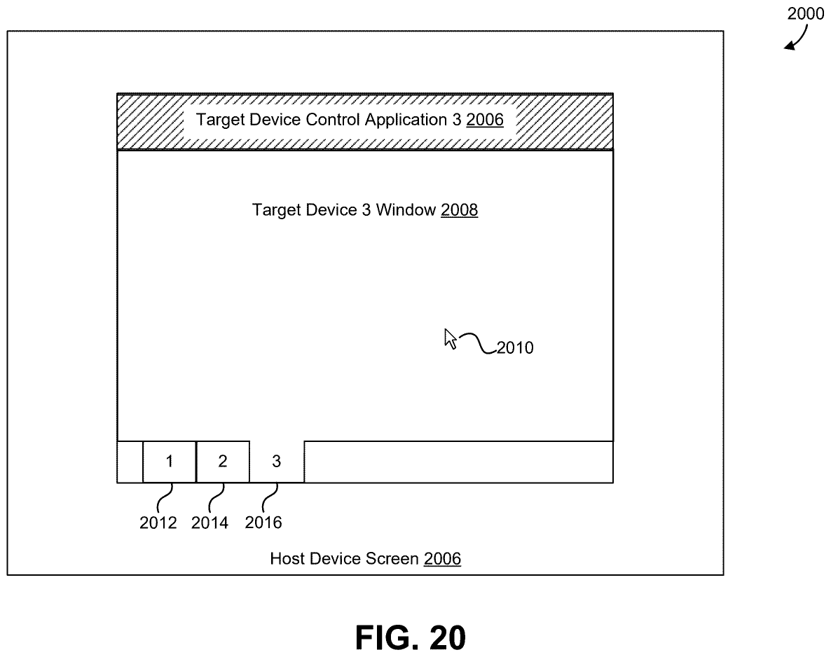

In some cases, an optional enhancement includes implementing a tabbed view within a single UI, where users can switch between different target computing devices using tabs, as illustrated in GUI 2000 of FIG. 20. In some cases, this tabbed view may be visually represented as a tab-control, or in other cases, may be a group of mutually exclusive buttons or other similar visual arrangements. This approach offers a centralized control interface while maintaining the ability to interact with each target computing device independently, via individually selectable tabs 2012, 2014, 2016 that prompt the application to display a corresponding window 2008. In other examples, a single application instance may utilize a single process to manage all connected target computing devices simultaneously. In some cases, while this approach consolidates control into a single process, it lacks process isolation for individual devices and can introduce unnecessary complexity, making debugging and performance optimization more challenging.

In summary, the multi-device control architecture retains compatibility with the existing single-device software while introducing minimal modifications to extend support for multiple target computing devices. Various embodiments allow flexibility in implementation, either through separate application instances, a tabbed interface, or a unified process approach. The preferred approach is to maintain independent application instances for each target computing device, ensuring process isolation and optimal reliability.

FIG. 21 illustrate an example process that may be performed by the target device control application, such as target device control application 1502 described above in reference to FIG. 15. In some aspects, process 2100 may be performed in conjunction with one or more of processes 1300 and/or 1400 described above. In some aspects, process 2100 may be performed or executed by a host computing device executing the target device control application. In some examples, the target device control application may be provided as a service, such as by one or more cloud computing providers, such that only a part of the computer executable instructions that define the application are actually stored on the host computing device.

As illustrated, process 2100 may begin at operation 2102, in which a target control application may detect a connection with a target computing device, such as via one or more messages sent by or through an integrated video and peripheral control device. In some optional examples, the application may receive one or more configuration parameters, such as may be presented to a user and received from a user through a graphical user interface, at operation 2104. In some cases, a graphical user interface, such as any of the user interfaces 1800, 1900, and/or 2000 described above in reference to FIGS. 18-20 may present and receive configuration parameter options/selections to enable configuration of various parameters, as described above.

Process 2100 may proceed to operation 2106, in which the application, via the host computing device, may establish a connection with the target computing device, such as through an integrated video and peripheral control device as described herein. In some cases, operation 1306 may include communicating various data with the target computing device and/or integrated video and peripheral control device, including one or more configuration parameters. Process 2100 may proceed to operation 2108, in which the application may obtain video and/or audio data or signal(s) from the target computing device, such as through an integrated video and peripheral control device as described herein. In some cases, the video and/or audio signals may be in a USB 3.0 or other format, such as may have been modified or converted by the integrated video and peripheral control device. In other cases, the audio and/or video data may in an original form sent by the target computing device.

Process 2100 may proceed to operation 2110, in which the application may process and display/.render the video and/or audio data, such as described above. The application may then receive one or more peripheral control device inputs, such as directed at a given target computing device (e.g., in a window corresponding to a given target computing device when there are multiple instances of the application executing on a single host computing device), at operation 2112. In some cases, the application may determine which target computing device a given input is directed based on a location of a cursor of the host machine, or other inputs or selections received by the host computing device. In some optional implementations, the application may then perform one or more pre-processing steps on the peripheral control device inputs, at operation 2114, as described in greater detail above.

Process 2100 may then proceed to operation 2116, in which the peripheral control device input may be sent to the target computing device, such as through an integrated video and peripheral control device. In some cases, the device inputs may be packages as control messages by the application, such as in operation 2114, to enable the integrated video and peripheral control device to readily recognize and convert the messages to be communicable to the target computing device. In various, cases, upon completion of operation 2116, process 2100 may loop back to operation 2108 and continue to interact with data from the target computing device and the peripheral control devise, to effectuate effective control of a target computing device through a host computing device.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, elements that are specifically shown in example embodiments should be construed to cover embodiments that comprise, consist essentially of, or consist of such elements, or such elements can be explicitly absent from further embodiments. Accordingly, the recitation of an element being present in one example should be construed to support some embodiments where such an element is explicitly absent.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). A number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (e.g., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In present document, references may be made to obtaining, acquiring, receiving, or inputting analog or digital data into a subsystem, computer system, or computer-implemented machine. Process of obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. An integrated video and peripheral control device, comprising:
one or more processors;
an upstream connector that supports a universal serial bus (USB) 3.0 or higher standard in communication with the one or more processors;
a first downstream connector that supports one or more of a high-definition multimedia interface (HDMI) standard or a display port standard for communication of video signals in communication with the one or more processors;
a second downstream connector that supports a USB 1.1 or higher standard in communication with the one or more processors; and
memory that stores computer-executable instructions that, if executed, cause the one or more processors to:
receive video input from a target computing device via the first downstream connector;
convert the received video input into USB 3.0 or higher video signal;
present the USB 3.0 or higher video signal via a USB Video Class (UVC) interface through the upstream connector to a host computing device;
receive one or more control messages from the host computing device via the upstream connector, the one or more control messages comprises instructions received from one or more peripheral control devices in communication with the host computing device;
convert the one or more control messages into one or more human interface device (HID) reports; and
using the one or more HID reports, provide emulation of the one or more peripheral control devices to the target computer via the second downstream connector.

2. The integrated video and peripheral control device of claim 1, wherein the one or more processors further comprise:
a first processor and a second processor, wherein the instructions that, if executed, cause the first processor to:
receive the video input from the target computing device via the first downstream connector;
convert the received video signals into USB 3.0 or higher video signals; and
present the USB 3.0 or higher video signals via the UVC interface through the upstream connector to the host computing device; wherein the instructions that, if executed, cause the second processor to:
receive the one or more control messages from the host computing device via the upstream connector;
convert the one or more control messages into the one or more HID reports; and
using the one or more HID reports, provide the USB keyboard and USB mouse emulation to the target computer via the second downstream connector.

3. The integrated video and peripheral control device of claim 2, wherein the first processor comprises one of a video processing chip or a graphics card.

4. The integrated video and peripheral control device of claim 2, wherein one or more of the first processor or the second processor comprises a microcontroller unit.

5. The integrated video and peripheral control device of claim 2, wherein the second processor comprises a USB communication component.

6. The integrated video and peripheral control device of claim 2, wherein the second processor comprises a USB serial chip.

7. The integrated video and peripheral control device of claim 1, wherein the one or more peripheral controls devices comprise a mouse and a keyboard.

8. The integrated video and peripheral control device of claim 1, further comprising:
second memory in communication with the upstream connector and the second downstream connector that provides data storage of user data communicated through the upstream connector.

9. The integrated video and peripheral control device of claim 1, further comprising:
second memory in communication with the upstream connector and the second downstream connector that provides shared storage of user data between host computing device through the upstream connector and the target computing device through the downstream connector.

10. The integrated video and peripheral control device of claim 1, wherein the one or more processors comprises a USB interface that provides one or more of a USB video output or a USB port for communication with the host computing device.

11. The integrated video and peripheral control device of claim 1, further comprising:
a third downstream connector that supports one or more of the HDMI standard or the display port standard for communication of video signals in communication with the one or more processors; and
a fourth downstream connector that supports a USB 1.1 or higher standard in communication with the one or more processors; wherein the memory stores additional computer-executable instructions that, if executed, further cause the one or more processors to:
receive video input from a second target computing device via the third downstream connector;
convert the received video signals into USB 3.0 or higher video signals;
present the USB 3.0 or higher video signals via the or another UVC interface through the upstream connector to the host computing device;
receive one or more control messages from the host computing device via the upstream connector, the one or more control messages comprises instructions received from the one or more peripheral control devices in communication with the host computing device;
convert the one or more control messages into one or more HID reports; and
using the one or more HID reports, provide emulation of the one or more peripheral control devices to the target computer via the fourth downstream connector.

12. The integrated video and peripheral control device of claim 1, further comprising:
one or more second processors;
a third downstream connector that supports one or more of the HDMI standard or the display port standard for communication of video signals in communication with the one or more second processors; and
a fourth downstream connector that supports a USB 1.1 or higher standard in communication with the one or more second processors; wherein the memory stores additional computer-executable instructions that, if executed, further cause the one or more second processors to:
receive second video input from a second target computing device via the third downstream connector;
convert the received video signals into USB 3.0 or higher video signals;
present the USB 3.0 or higher video signals via the or another UVC interface through the upstream connector to the host computing device;
receive one or more control messages from the host computing device via the upstream connector, the one or more control messages comprises instructions received from the one or more peripheral control devices in communication with the host computing device;
convert the one or more control messages into one or more HID reports; and
using the one or more HID reports, provide emulation of the one or more peripheral control devices to the target computing device via the fourth downstream connector.

13. The integrated video and peripheral control device of claim 12, further comprising:
a hub device in communication with the one or more processors, the one or more second processors, and the memory, wherein the memory stores additional computer-executable instructions that, if executed, further cause the one or more second processors to:
route the video input and the second video input from the target computing device and the second target computing device to the host computing device; and
route control messages from the host computing device to the corresponding target computing device or the second target computing device.

14. The integrated video and peripheral control device of claim 13, wherein the one or more processors are part of a first control device and the one or more second processors are part of a second control device.

15. The integrated video and peripheral control device of claim 14, wherein the control device and the second control device are in communication with the hub device via one or more separate USB connections.

16. An integrated video and peripheral control device, comprising:
one or more processors;
an upstream connector connected to the one or more processors;
a first downstream connector that supports communication of one or more of video or audio signals, wherein the first downstream connector is in communication with the one or more processors;
a second downstream connector in communication with the one or more processors; and
memory that stores computer-executable instructions that, if executed, cause the one or more processors to:
receive video input from a target computing device via the first downstream connector;
convert the received video signals into processed video signals;
present the processed video signals via a video interface through the upstream connector to a host computing device;
receive one or more control messages from the host computing device via the upstream connector, the one or more control messages comprises instructions received from one or more peripheral control devices in communication with the host computing device;
convert the one or more control messages into one or more human interface device (HID) reports; and
using the one or more HID reports, provide emulation of the one or more peripheral control devices to the target computer via the second downstream connector.

17. The integrated video and peripheral control device of claim 16, wherein the integrated video and peripheral control device is part of an integrated video and peripheral control system, the system further comprising:
a target device control application executable by the host computing system, wherein the target device control application upon executing computer-executable instructions:
obtains one or more peripheral control device inputs; and
converts the one or more peripheral control device inputs into one or more control messages prior to sending the one or more control messages to the target computing device through the integrated video and peripheral control device.

18. The integrated video and peripheral control device of claim 17, wherein the target device control application upon executing computer-executable instructions further:
upon obtaining the processed video signals, renders the processed video signals in a graphical user interface provided by the target device control application.

19. A computer-implemented method for interfacing with a target computing device through a peripheral control device, the method comprising:
receiving video input from a target computing device via a first downstream port;
converting the received video input into a processed video signal;
presenting the processed video signal via a video interface through an upstream port to a host computing device;
receiving one or more control messages from an application executed by the host computing device via the upstream connector, the one or more control messages comprises instructions received from one or more peripheral control devices in communication with the host computing device;
converting the one or more control messages into one or more human interface device (HID) messages; and
using the one or more HID messages, providing emulation of the one or more peripheral control devices to the target computing device via a second downstream port.

20. The method of claim 19, further comprising:
receiving second video input from a second target computing device via another first downstream port;
converting the received second video input into a processed video signal;
presenting the processed video signal via the video interface or a second video interface through the upstream port to the host computing device;
receiving one or more second control messages from the application executed by the host computing device via the upstream connector, the one or more control messages comprises instructions received from one or more peripheral control devices in communication with the host computing device directed to the second target device;
converting the one or more second control messages into one or more second human interface device (HID) messages; and
using the one or more second HID messages, providing emulation of the one or more peripheral control devices to the second target computing device via another second downstream port.
